(19) United States
(12) Patent Application Publication
(10) Pub. No.: US 2025/0294277 A1
(43) Pub. Date: Sep. 18, 2025

(54) PORTABLE SOUND EMITTING DEVICE

(71) Applicant: Marpac, LLC, Wilmington, NC (US)

(72) Inventors: Chris Pageau, Greenville, SC (US); Scott Peterson, Omaha, NE (US); Robert Rouse, Wilmington, NC (US)

(73) Assignee: Marpac, LLC, Wilmington, NC (US)

(21) Appl. No.: 19/080,050

(22) Filed: Mar. 14, 2025

Related U.S. Application Data
(60) Provisional application No. 63/565,144, filed on Mar. 14, 2024.

(51) Int. Cl. H04R 1/02; H01H 13/02; H01M 10/46

(52) U.S. Cl. CPC H04R 1/026; H01H 13/023; H01M 10/46; H01M 2220/30

(57) ABSTRACT

Various portable sound emitting devices and methods of manufacturing the same are provided. An example portable sound emitting device includes a device housing comprising at least one engageable button, wherein each of the at least one engageable button is backlit. The portable sound emitting device also includes a sound emitting component within the device housing. The sound emitting component is controlled via the at least one engageable button. The portable sound emitting device further includes a rechargeable battery coupled to the sound emitting component within the device housing.

### CROSS-REFERENCE TO RELATED APPLICATIONS

The present application claims the benefit and priority to U.S. Provisional Patent Application No. 63/565,144, filed on Mar. 14, 2024; the contents of which are incorporated herein by reference.

### FIELD

An example embodiment relates generally to sound emitting devices and more particularly, to portable sound emitting devices.

### BACKGROUND

Sound emitting devices are often used to promote sleep. Therefore, sound emitting devices are typically used in low-light settings. Making adjustments to sound emitting devices are typically done via buttons on the device. The buttons are difficult to see due to the low-light setting, making it difficult to successfully interact with the sound emitting device once the lights are turned off in a room. As such, there exists a need for a system that can provide for a portable sound emitting device with backlit engageable buttons.

### SUMMARY

The following paragraphs present a summary of various embodiments of the present disclosure and are merely examples of potential embodiments. As such, the summary is not meant to limit the subject matter or variations of various embodiments discussed herein.

In some aspects, the techniques described herein relate to a portable sound emitting device, the device including: a device housing including at least one engageable button, wherein each of the at least one engageable button is backlit; a sound emitting component within the device housing, wherein the sound emitting component is controlled via the at least one engageable button; and a rechargeable battery coupled to the sound emitting component within the device housing.

In some aspects, the techniques described herein relate to a device, wherein the at least one engageable button is backlit via an amber colored light.

In some aspects, the techniques described herein relate to a device, wherein the at least one engageable button includes a power button, a lock button, and at least volume control button.

In some aspects, the techniques described herein relate to a device, further including a timer, wherein the timer controls a length of time the sound emitting component is activated.

In some aspects, the techniques described herein relate to a device, wherein the timer is controlled via one of the at least one engageable button.

In some aspects, the techniques described herein relate to a device, wherein the rechargeable battery is rechargeable via a charging port defined on the device housing.

In some aspects, the techniques described herein relate to a device, wherein the rechargeable battery is rechargeable via a wireless connection.

In some aspects, the techniques described herein relate to a device, wherein the at least one engageable button includes a lock button, wherein at least one of the at least one engageable button is inactive in an instance in which the lock button is engaged. at least one engageable button.

In some aspects, the techniques described herein relate to a device, further including a clipping mechanism attached to the device housing.

In some aspects, the techniques described herein relate to a device, further including a carabineer attachable to the clipping mechanism, wherein the carabineer is structured to attach the device housing to an object.

In some aspects, the techniques described herein relate to a method of manufacturing a portable sound emitting device, the method including: providing a device housing including at least one engageable button, wherein each of the at least one engageable button is backlit; providing a sound emitting component within the device housing, wherein the sound emitting component is controlled via the at least one engageable button; and coupling a rechargeable battery to the sound emitting component within the device housing.

In some aspects, the techniques described herein relate to a method, wherein the at least one engageable button is backlit via an amber colored light.

In some aspects, the techniques described herein relate to a method, wherein the at least one engageable button includes a power button, a lock button, and at least volume control button.

In some aspects, the techniques described herein relate to a method, further including connecting a timer to the sound emitting component, wherein the timer controls a length of time the sound emitting component is activated.

In some aspects, the techniques described herein relate to a method, wherein the timer is controlled via one of the at least one engageable button.

In some aspects, the techniques described herein relate to a method, wherein the rechargeable battery is rechargeable via a charging port defined on the device housing.

In some aspects, the techniques described herein relate to a method, wherein the rechargeable battery is rechargeable via a wireless connection.

In some aspects, the techniques described herein relate to a method, wherein the at least one engageable button includes a lock button, wherein at least one of the at least one engageable button is inactive in an instance in which the lock button is engaged. at least one engageable button.

In some aspects, the techniques described herein relate to a method, further including defining a clipping mechanism on the device housing.

In some aspects, the techniques described herein relate to a method, further including providing a carabineer attachable to the clipping mechanism, wherein the carabineer is structured to attach the device housing to an object.

### BRIEF DESCRIPTION OF THE DRAWINGS

Many aspects of the present disclosure will be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views. It should be recognized that these implementations and embodiments are merely illustrative of the principles of the present disclosure. Therefore, in the drawings:

FIGS. 1A and 1B are multiple views of an example portable sound emitting device, in accordance with various embodiments;

FIG. 2 is an engineering drawing of a backside of the example portable sound emitting device, in accordance with various embodiments;

FIGS. 3A-3D are various sides of the example portable sound emitting device, in accordance with various embodiments;

FIG. 4 illustrates an example carabineer attached to the clipping mechanism of the example portable sound emitting device, in accordance with various embodiments;

FIGS. 5A-5C are various views of the carabineer of FIG. 4, in accordance with various embodiments;

FIGS. 6A-6C illustrate a flowchart of operations of an example portable sound emitting device in accordance with various embodiments; and

FIG. 7 is a flowchart of an example method of manufacturing a portable sound emitting device, in accordance with various embodiments.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements.

Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

Throughout this specification and the claims, the terms “comprise,” “comprises”, and “comprising” are used in a non-exclusive sense, except where the context requires otherwise. Likewise, the term “includes” and its grammatical variants are intended to be non-limiting, such that recitation of items in a list is not to the exclusion of other like items that can be substituted or added to the listed items.

### I. Example Use Case

In some aspects, the techniques described herein relate to a portable sound emitting device, the device including: a device housing including at least one engageable button, wherein each of the at least one engageable button is backlit; a sound emitting component within the device housing, wherein the sound emitting component is controlled via the at least one engageable button; and a rechargeable battery coupled to the sound emitting component within the device housing.

In some aspects, the techniques described herein relate to a device, wherein the at least one engageable button is backlit via an amber colored light.

In some aspects, the techniques described herein relate to a device, wherein the at least one engageable button includes a power button, a lock button, and at least volume control button.

In some aspects, the techniques described herein relate to a device, further including a timer, wherein the timer controls a length of time the sound emitting component is activated.

In some aspects, the techniques described herein relate to a device, wherein the timer is controlled via one of the at least one engageable button.

In some aspects, the techniques described herein relate to a device, wherein the rechargeable battery is rechargeable via a charging port defined on the device housing.

In some aspects, the techniques described herein relate to a device, wherein the rechargeable battery is rechargeable via a wireless connection.

In some aspects, the techniques described herein relate to a device, wherein the at least one engageable button includes a lock button, wherein at least one of the at least one engageable button is inactive in an instance in which the lock button is engaged. at least one engageable button.

In some aspects, the techniques described herein relate to a device, further including a clipping mechanism attached to the device housing.

In some aspects, the techniques described herein relate to a device, further including a carabineer attachable to the clipping mechanism, wherein the carabineer is structured to attach the device housing to an object.

In some aspects, the techniques described herein relate to a method of manufacturing a portable sound emitting device.

### II. Systems and Methods

Sound emitting devices are typically used in bedroom and in low light situations to aid with sleep for users. Many sound devices use tactile indicators on the buttons to allow the user to interface with the sound emitting device in the dark. However, tactile indicators still make it difficult for a user to determine which button is being pressed. As such, there exists a need for a sound emitting device that allows for buttons that provide assistance to users to operate in low-light settings. Various embodiments of the present disclosure provide for a sound emitting device that improves usability in low-light settings, allowing users to engage with the sound emitting device without having to turn on any lights in the room that may cause other people in the room to be awaken.

In various embodiments of the present disclosure, example portable sound emitting devices are provided. The example portable sound emitting devices include backlit buttons and rechargeable batteries. The engageable button(s) provided on the portable sound emitting devices may include a visual marker for the functionality of the given button. For example, the engageable button(s) may include a power button, one or more volume control buttons, a timer button, a lock button, and/or the like. Each of the engageable button(s) may be backlit. For example, at least a portion of each engageable button (e.g., the functionality marker) may be transparent, such that a light may be emitted there through. As such, the functionality marker may be visible during low-light instances. In various embodiments, the engageable button(s) may be constantly backlit (e.g., while the portable sound emitting device is powered on) or the engageable button(s) may be selectively backlit (e.g., in an instance the portable sound emitting device is in a dark or otherwise low-light setting).

The backlit of the engageable buttons may be a colored light designed to promote sleep for a user (e.g., produce a non-disturbing environment for a user). As such, the backlit may be an amber colored light. Amber colored light promotes the production of melatonin and shortens the time to sleep onset for a user. As such, an amber colored light may be used to backlit the engageable button(s). The amber color backlit may be provided via one or more light sources, such as one or more LED light sources.

In an example embodiment, in an instance the engageable button(s) are short pressed (e.g., engaged for less than a predetermined period of time) and the unit is in the off state—the backlit of the engageable buttons turn on temporarily (e.g., the button(s) may be backlit for 10 seconds). In such an instance, the backlit may be turned off in an instance no additional engageable button(s) are pressed during the temporary backlit.

In various embodiments, the engageable button(s) may determine functionality of the portable sound emitting device. In an instance in which the power button is long pressed (e.g., engaged for more than a predetermined period of time), the portable sound emitting device may be powered on and the engageable button(s) may be backlit (e.g., until the portable sound emitting device is turned off by the power button being long pressed or a predetermined amount of time has passed since previous engagement of the engageable button(s)). In an instance in which the portable sound emitting device is powered off, the light(s) providing the backlit to the engageable button(s) may also be turned off. In various embodiments, the portable sound emitting device may have a night-light mode in which the engageable button(s) are backlit until the night-light mode is turned off. The portable sound emitting device may also have one or more additional lights that provide the night-light in addition to the backlit engageable button(s). The night-light mode may be toggled via a night-light button of the engageable button(s). In an instance in which both the sound and night light are turned on and the user long presses the power button, the sound, night light, and the backlit of the engageable button(s) may each be turned off.

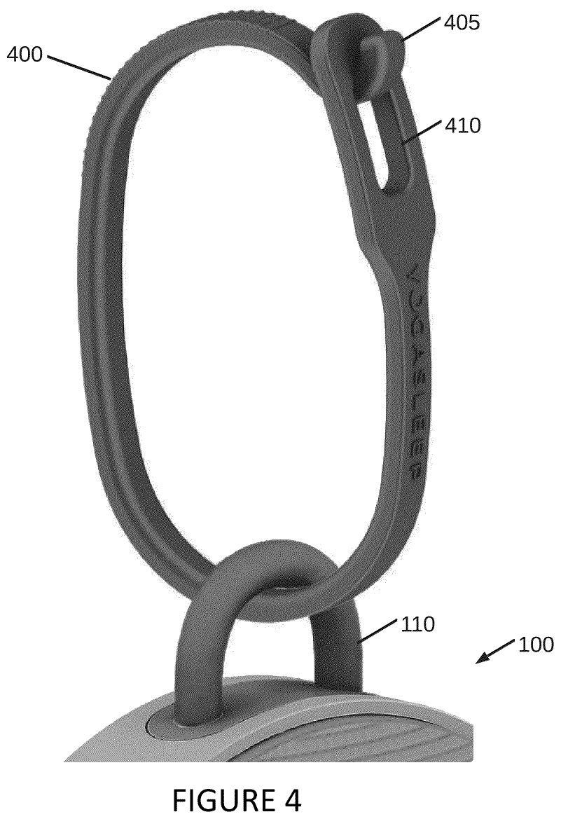

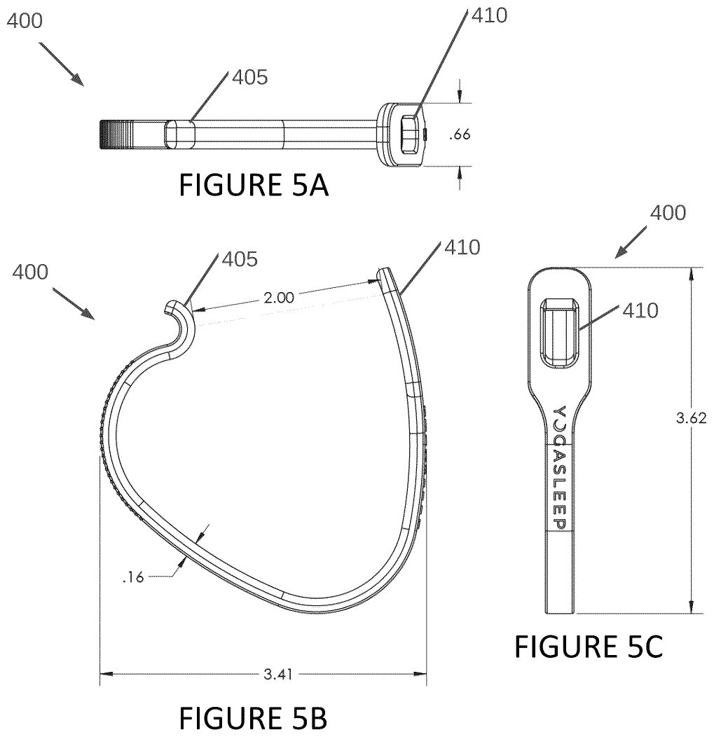

In various embodiments, the portable sound emitting device may also a clipping mechanism that allows for the portable sound emitting device to be attached to a structure or object, such as a crib or hook. The clipping mechanism may be attachable to such a structure or object via a carabineer. The carabineer, as shown in FIGS. 4 and 5A-5C, may be designed for one handed operating, such that a user may attach and/or detach the carabineer with a single free hand.

### III. With Reference to the Figures

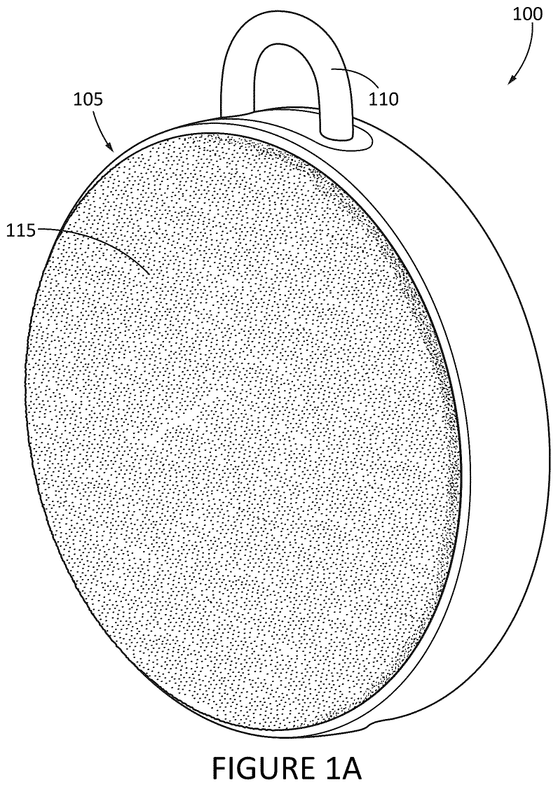

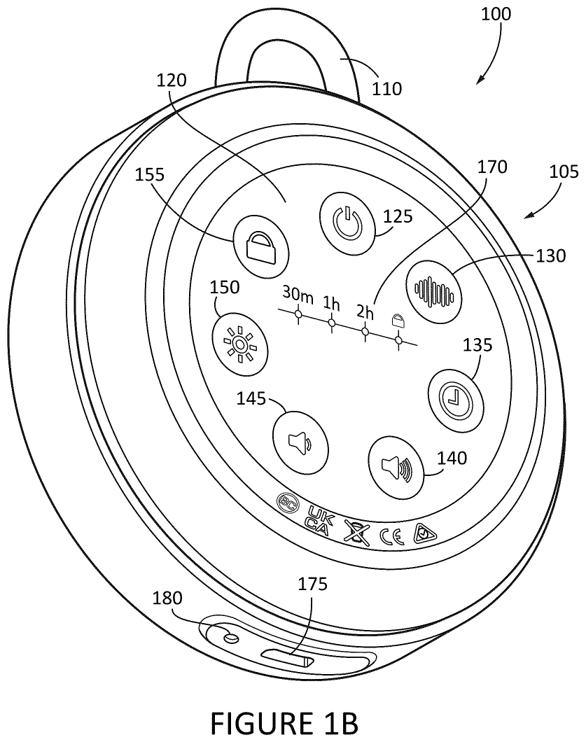

Referring now to FIGS. 1A, 1B, 2, and 3A-3D, various views of an example sound emitting device 100 are shown. While the sound emitting devices discussed herein are portable (e.g., having a rechargeable battery), various embodiments of the present disclosure may be non-portable or otherwise stationary (e.g., needing to be connected to a power source in order to operate).

The sound emitting device 100 may be portable. In various embodiments, the sound emitting device 100 may have a device housing 105 that houses the components of the sound emitting device discussed herein. The device housing 105 may have a speaker side 115 (shown in FIG. 1A) and a button side 120 (shown in FIG. 1B). The device housing 105 may be a generally circular cross-sectional shape as shown. Alternatively, the device housing 105 may be other cross-sectional shapes (e.g., square, rectangular, triangular, etc.).

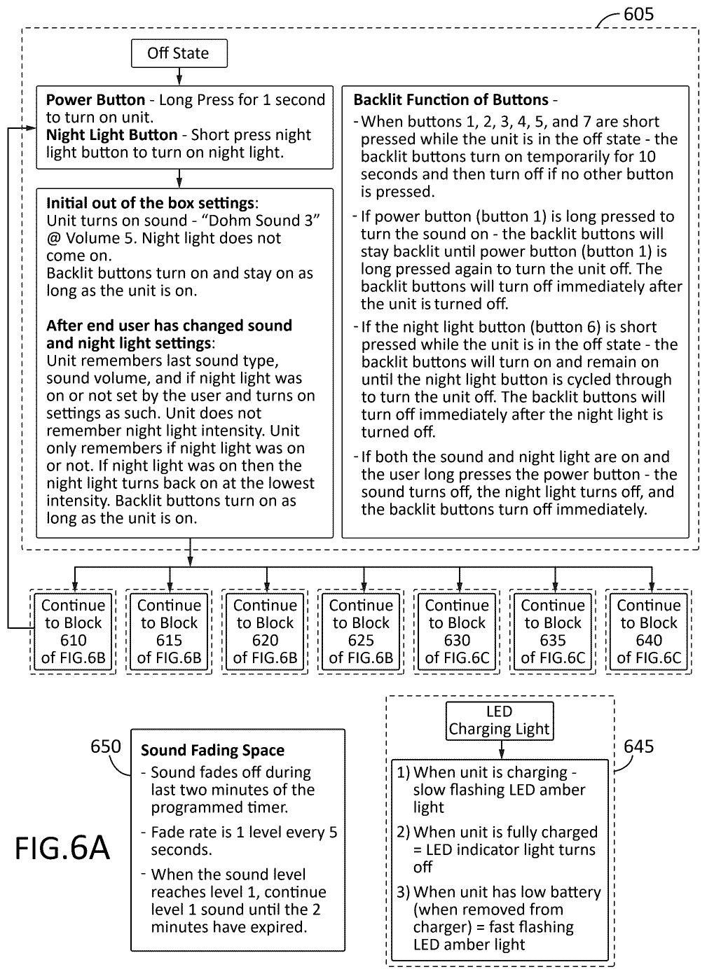

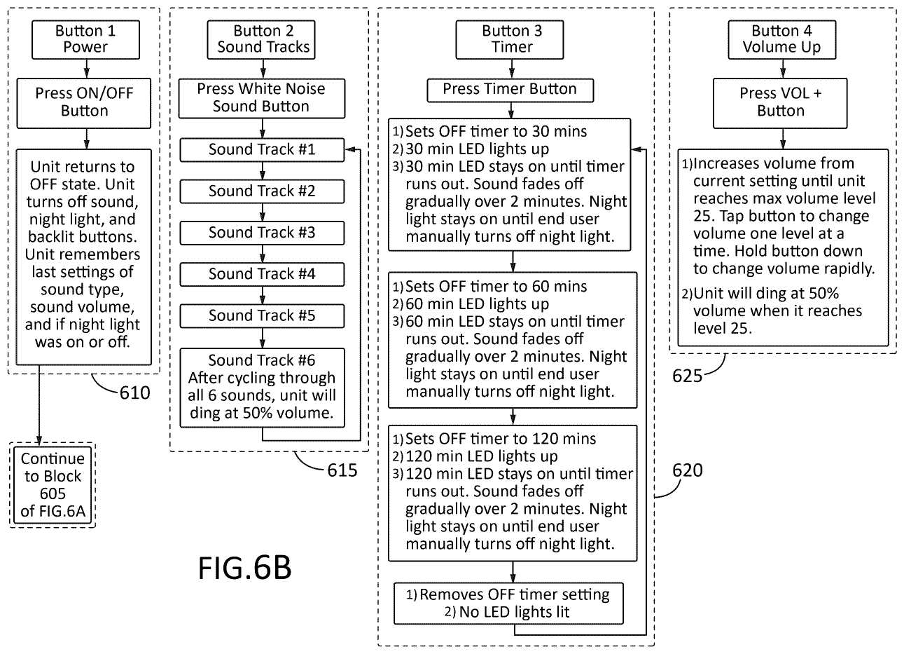

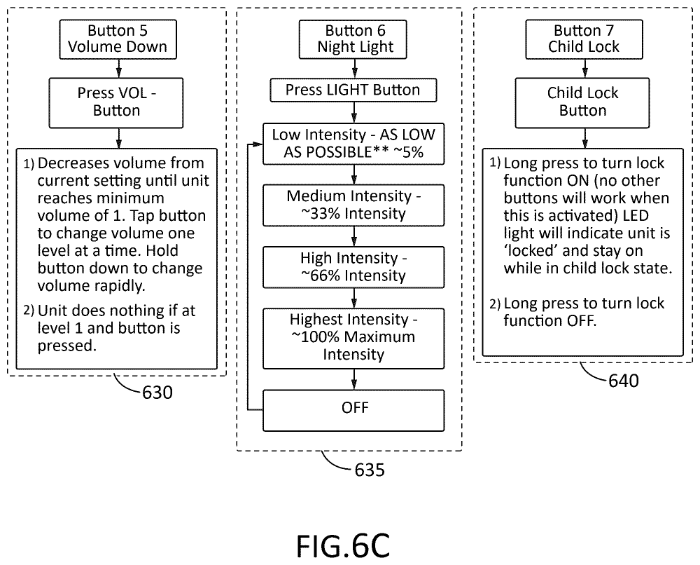

The device housing 105 may house a sound emitting component (e.g., a speaker and speaker components). The sound emitting component may be configured to emit sound (e.g., a soundtrack as discussed in reference to FIGS. 6A-6C). The sound emitting component may be positioned within the device housing 105 such that the sound is emitted via the speaker side 115 of the device housing. For example, the speaker side 115 may include a speaker cover material to allow the sound to pass through (e.g., to the environment).

The device housing 105 may include a rechargeable battery. The rechargeable battery size and capacity may be based on the size and usage of a given sound emitting device. The rechargeable battery may be charged via a wired connection. For example, a charging cable may be connected via charging port 175 shown in FIG. 1B. Additionally or alternatively, the rechargeable battery may be charged wirelessly (e.g., via a wireless charging pad). The sound emitting device 100 may include a charging light that is turned on in an instance in which the rechargeable battery is being charged. In some instances, the charging light 180 may also be lit to indicate a low battery and/or other battery information.

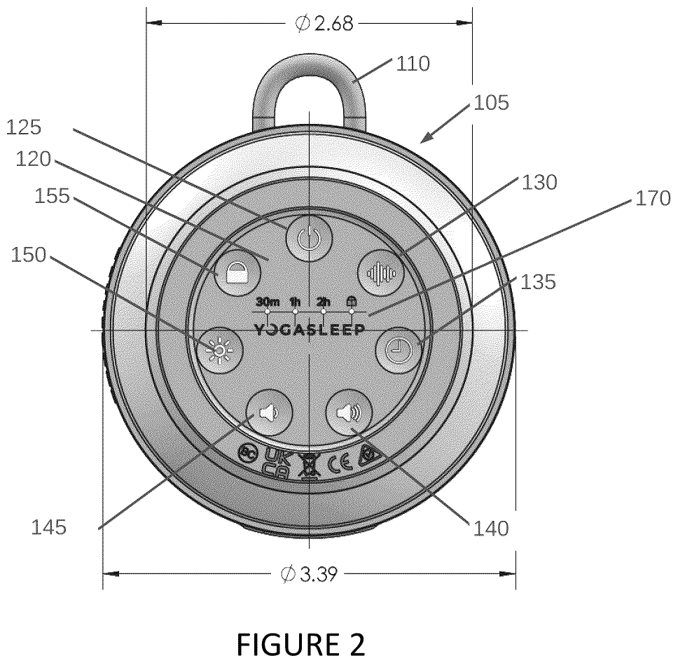

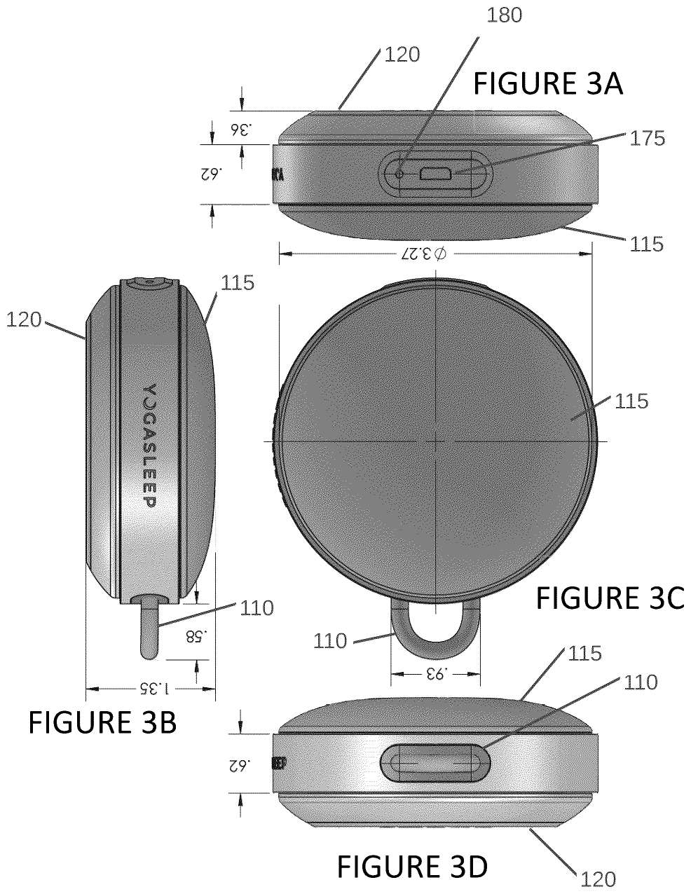

As shown in FIG. 1B, the button side 120 of the device housing 105 may include one or more engageable button(s). Example engageable button(s) include a power button 125, a soundtrack button 130, a timer button 135, a volume up button 140, a volume down button 145, a night light button 150, and a lock button 155. Sound emitting devices of various embodiments may include more or less different engageable button types. FIGS. 2 and 3A-3D include various sides of the sound emitting device 100 with dimensions of an example sound emitting device. In various embodiments, the dimensions may be different.

The various engageable button(s) are discussed in more detail below in reference to FIGS. 6A-6C. The power button 125, upon engagement, may turn the sound emitting device 100 from the off state to the on state or vice versa. The soundtrack button 130, upon engagement, allows for a user to toggle between different soundtracks to be played via the sound emitting component. The timer button 135, upon engagement, allows a user to toggle between different preset timer values. As shown by the timer indicator 170 of FIGS. 1B and 2, the timer indicator 170 indicates the timer value selected (e.g., example timer values include 30 minutes, 60 minutes, 120 minutes, etc.). The volume up button 140 and the volume down button 145, upon engagement, allow the user to adjust the volume of the sound emitting component. The night light button 150, upon engagement, allows the user to turn on the night light feature and/or adjust the intensity of the night light. The lock button 155, upon engagement, allows for the user to deactivate other engageable button(s) in an instance in which the sound emitting device 100 is in lock mode.

In various embodiments, each of the engageable buttons may be backlit via one or more light sources. The backlit of the engageable buttons may be a colored light designed to promote sleep for a user (e.g., produce a non-disturbing environment for a user). As such, the backlit may be an amber colored light. Amber colored light promotes the production of melatonin and shortens the time to sleep onset for a user. As such, an amber colored light may be used to backlit the engageable button(s). The amber color backlit may be provided via one or more light sources, such as one or more LED light sources.

Referring now to FIGS. 4 and 5A-5C, various views of a carabineer 400 attachable to a clipping mechanism of the sound emitting device 100 (e.g., a portable sound emitting device) are shown. In various embodiments, the carabineer 400 may open at a first end and a second end. The first end may define a hook 405 that is structured to engaged with the hook aperture 410 defined at the second end of the carabineer 400. In various embodiments, as shown in FIG. 5B, the natural form of the carabineer 400 is a generally D-shape, with a predetermined distance between the hook 405 and the hook aperture 410 (e.g., in the example carabineer 400 shown, the predetermined distance between the hook 405 and the hook aperture 410 is 2 inches). In various embodiments, the form of the carabineer 400 allows for a single hand to be used to open and close the carabineer (e.g., engage and/or disengage the hook 405 and the hook aperture 410). Upon engagement of the hook 405, the carabineer 400 is held together (e.g., attaching the sound emitting device 100 to an object (e.g., via the clipping mechanism 110).

Referring now to FIGS. 6A-6C, a flowchart 600 of the operations of an example sound emitting device 100 (e.g., a portable sound emitting device) is provided. The operations shown in FIGS. 6A-6C are illustrative. As such, various sound emitting devices may be programed with the same or similar operations using the engageable button(s) of various embodiments.

As shown in Block 605 of FIG. 6A, the power button and/or the night light button may be engageable in instance the sound emitting device is in an off state. The power button, when pressed for a predetermined amount of time (e.g., pressed for one second or longer) may turn on the unit and the night light may be turned on (e.g., via a short press). The sound emitting device may have default settings (e.g., “out of box settings”). For example, as shown, in various embodiments, the default settings may include the default soundtrack and/or default sound level upon the sound emitting device being turned on (e.g., “Dohm Sound 3” @ Volume 5), whether the night light comes on in an instance the power button is used to turn on the unit, whether the backlit of the engageable buttons is turned on while the unit is powered, and/or the like. In various embodiments, the default settings may be updated by a user and stored by the sound emitting device (e.g., the sound emitting device may have a processing device and memory device in order to store and carrying out the updated settings). Block 605 of FIG. 6A also include information on how the backlit functionality operates for the engageable button(s). For example, the engageable button(s) may be temporarily backlit in an instance in which one of the engageable buttons is pressed (e.g., in an instance in which any engageable button(s) other than the night light button is short pressed, the engageable button(s) may be backlit for a predetermined amount of time, such as 10 seconds).

Blocks 610, 615, 620, 625, 630, 635, and 640, are each directed to the operations of different engageable buttons in accordance with various embodiments once the sound emitting device is in the on state (e.g., powered on via the power button). In an example embodiment, each sub-block within a block indicates the operation performed in an instance the given button is pressed.

Referring now to Block 610 of FIG. 6B, in an instance in which the power button (e.g., power button 125 shown in FIGS. 1B and 2) is engaged after the sound emitting device has been powered (e.g., as shown in Block 605 of FIG. 6A), the sound emitting device may return to the off state (e.g., unit turns off sound, backlit engageable button(s), night light, etc.).

Referring now to Block 615 of FIG. 6B, in an instance in which the soundtrack button (e.g., soundtrack button 130 shown in FIGS. 1B and 2) is engaged, a first soundtrack (“Soundtrack #1”) may be played (e.g., via the sound emitting component). Each time the soundtrack button is pressed, a different soundtrack is played. For example, in an instance there are six soundtracks, the soundtracks may be cycled through upon each subsequent engagement of the soundtrack button.

Referring now to Block 620 of FIG. 6B, in an instance in which the timer button (e.g., timer button 135 shown in FIGS. 1B and 2) is engaged, the timer may be set to a predetermined time (e.g., 30 minutes). Each subsequent engagement of the timer button may change the timer time (e.g., cycle between two or more preset values, such as 30 minutes, 60 minutes, 120 minutes, and no limit). The timer amount may be provided to the user via the timer indicator 170. As shown in FIG. 2, a light may be provided for each preset value of the timer and the light corresponding to the currently selected value may be turned on while the light for the other values remains off (e.g., as shown in FIG. 2, the 30-minute timer value is selected). Block 650 of FIG. 6A includes additional features of the timer in accordance with various embodiments. As shown, the sound may fade as the timer is approaching an ending point (e.g., the sound may fade off for a predetermined fade time, such as the remaining 2 minutes of the programmed timer). In such an instance, the fade may have a fade rate that slowly turns down the volume (e.g., the fade rate may be 1 level for every 5 seconds, such that the volume is decreased by one level every five second until the volume reach level one or the predetermined amount of fade time is ended).

Referring now to Block 625 of FIG. 6B, in an instance in which the volume up button (e.g., volume up button 140 shown in FIGS. 1B and 2) is engaged, the volume will be increased (e.g., increased by a predetermined amount, such as an increase of one level of sound until a max volume is reached). For example, the volume may have a range of 0 to 25, with 1 being the minimum volume and 25 being the max volume. Each time the volume up button is pressed, the volume is increased by one until the volume reaches level 25.

Referring now to Block 630 of FIG. 6C, in an instance in which the volume down button (e.g., volume down button 145 shown in FIGS. 1B and 2) is engaged, the volume will be decreased (e.g., increased by a predetermined amount, such as a decrease of one level of sound until a minimum volume is reached). For example, the volume may have a range of 0 to 25, with 1 being the minimum volume and 25 being the max volume. Each time the volume down button is pressed, the volume is decreased by one until the volume reaches level 1.

Referring now to Block 635 of FIG. 6C, in an instance in which the night light button (e.g., night light button 150 shown in FIGS. 1B and 2) is engaged, the intensity of the night light is adjusted. For example, each press of the night light button may cycle through different intensity levels of the night light (e.g., between low intensity, medium intensity, high intensity, highest intensity, and off). The number of different intensities may vary. The night light may be part of the speaker side 115 of the sound emitting device. As such at least a portion of the speaker side 115 may be lit via the night light upon being activated.

Referring now to Block 640 of FIG. 6C, in an instance in which the lock button (e.g., lock button 155 shown in FIGS. 1B and 2) is engaged, one or more of the engageable buttons may be deactivated. In various embodiments, the lock button may be referred to as a “child lock.” However, the lock button may provide lock protection from different users (e.g., caused by accidental engagement of an engageable button). As shown, a long press (e.g., engagement of the given button for a predetermined amount of time) may turn the lock functionality on. In such an instance, the engageable button(s) may be deactivated (e.g., caused not to respond to engagement) until the lock mode is turned off (e.g., via a long press of the lock button).

Block 645 of FIG. 6A indicates the functionality of a charging light (e.g., an LED charging light). An example charging light 180 is shown in FIGS. 1B and 3A. The charging light 180 may be illuminated in an instance the battery is being charged (e.g., via a charging wire or wireless charging).

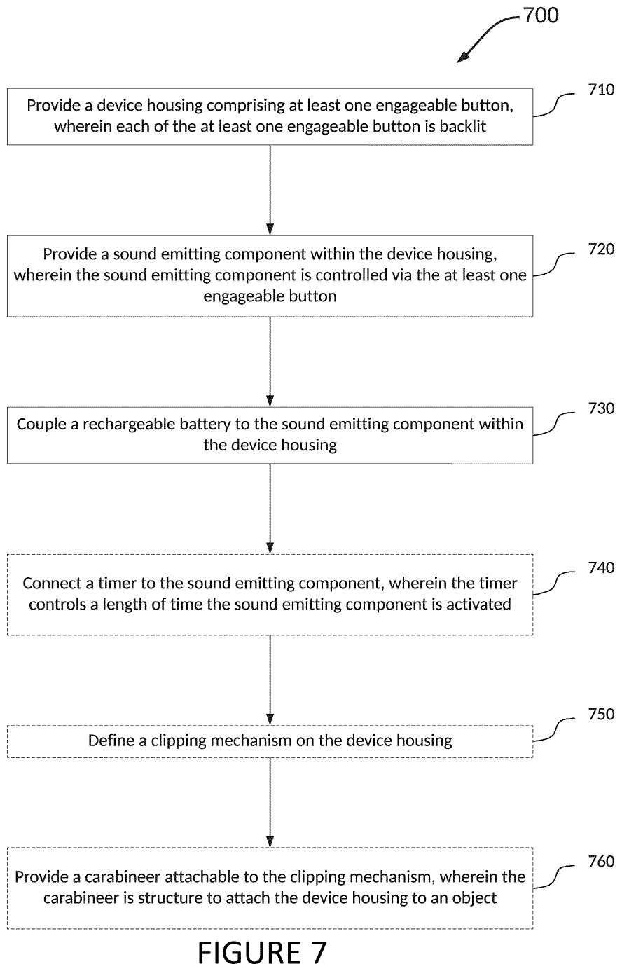

Referring now to FIG. 7, a flowchart 700 of an example method of manufacture of an example sound emitting device 100 is provided. In various embodiments, the method of manufacture may be used to manufacture any of the various embodiments of example sound emitting devices discussed herein. As such, the method of manufacture may include providing any of the features of the example portable sound emitting devices discussed herein.

Referring now to Block 710 of FIG. 7, the method includes providing a device housing comprising at least one engageable button. In various embodiments, the engageable button(s) may be any of the engageable buttons discussed herein (e.g., a power button 125, a soundtrack button 130, a timer button 135, a volume up button 140, a volume down button 145, a night light button 150, a lock button 155, etc.). The engageable button(s) may be backlit. The color of the backlit of the engageable button(s) may be amber (or other color that promote sleep for a user).

Referring now to Block 720 of FIG. 7, the method includes providing a sound emitting component within the device housing. The sound emitting component may be a speaker or the like. The sound emitting component is controlled via the at least one engageable button (e.g., the sound emitting component may be turned on via the power button 125, the volume of the sound emitting component may be controlled via the volume up button 140 and/or the volume down button 145, etc.)

Referring now to Block 730 of FIG. 7, the method includes coupling a rechargeable battery to the sound emitting component within the device housing. The rechargeable battery may power the controller (e.g., a processing device) and/or the sound emitting component of the sound emitting device 100. The rechargeable battery may be charged via a charging port defined on the device housing. Additionally, or alternatively, the rechargeable battery may be rechargeable via a wireless connection.

Referring now to optional Block 740 of FIG. 7, the method includes connecting a timer to the sound emitting component. The timer may control a length of time the sound emitting component is activated. The timer may have the functionality discussed herein. The timer may be controlled via the timer button 135, as discussed herein. Additionally, the timer indicator 170 discussed herein may provide information relating to the timer (e.g., indicate the timer value selected).

Referring now to optional Block 750 of FIG. 7, the method includes defining a clipping mechanism on the device housing. The clipping mechanism 110 may be provided as shown in FIGS. 1A, 1B, and 2. The clipping mechanism may define a connection method in which a carabineer 400 or the like may be connected. In various embodiments, the carabineer 400 and the clipping mechanism 110 may be combined (e.g., a unitary carabineer may be attached to the device housing 105).

Referring now to optional Block 760 of FIG. 7, the method includes providing a carabineer attachable to the clipping mechanism. The carabineer 400 is shown and discussed in reference to FIGS. 4 and 5A-5C. The carabineer 400 is structured to be attached to the clipping mechanism 110.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A portable sound emitting device, the device comprising:
a device housing comprising at least one engageable button, wherein each of the at least one engageable button is backlit;
a sound emitting component within the device housing, wherein the sound emitting component is controlled via the at least one engageable button; and
a rechargeable battery coupled to the sound emitting component within the device housing.

2. The device of claim 1, wherein the at least one engageable button is backlit via an amber colored light.

3. The device of claim 1, wherein the at least one engageable button comprises a power button, a lock button, and at least volume control button.

4. The device of claim 1, further comprising a timer, wherein the timer controls a length of time the sound emitting component is activated.

5. The device of claim 4, wherein the timer is controlled via one of the at least one engageable button.

6. The device of claim 1, wherein the rechargeable battery is rechargeable via a charging port defined on the device housing.

7. The device of claim 1, wherein the rechargeable battery is rechargeable via a wireless connection.

8. The device of claim 1, wherein the at least one engageable button comprises a lock button, wherein at least one of the at least one engageable button is inactive in an instance in which the lock button is engaged. at least one engageable button.

9. The device of claim 1, further comprising a clipping mechanism attached to the device housing.

10. The device of claim 9, further comprising a carabineer attachable to the clipping mechanism, wherein the carabineer is structured to attach the device housing to an object.

11. A method of manufacturing a portable sound emitting device, the method comprising:
providing a device housing comprising at least one engageable button, wherein each of the at least one engageable button is backlit;
providing a sound emitting component within the device housing, wherein the sound emitting component is controlled via the at least one engageable button; and
coupling a rechargeable battery to the sound emitting component within the device housing.

12. The method of claim 11, wherein the at least one engageable button is backlit via an amber colored light.

13. The method of claim 11, wherein the at least one engageable button comprises a power button, a lock button, and at least volume control button.

14. The method of claim 11, further comprising connecting a timer to the sound emitting component, wherein the timer controls a length of time the sound emitting component is activated.

15. The method of claim 14, wherein the timer is controlled via one of the at least one engageable button.

16. The method of claim 11, wherein the rechargeable battery is rechargeable via a charging port defined on the device housing.

17. The method of claim 11, wherein the rechargeable battery is rechargeable via a wireless connection.

18. The method of claim 11, wherein the at least one engageable button comprises a lock button, wherein at least one of the at least one engageable button is inactive in an instance in which the lock button is engaged. at least one engageable button.

19. The method of claim 11, further comprising defining a clipping mechanism on the device housing.

20. The method of claim 19, further comprising providing a carabineer attachable to the clipping mechanism, wherein the carabineer is structured to attach the device housing to an object.
